(19) United States
(12) Patent Application Publication
(10) Pub. No.: US 2014/0283753 A1
(43) Pub. Date: Sep. 25, 2014

(54) LITTER AND WASTE SEPARATOR

(71) Applicants: Daniel William Dawn, Inver Grove Heights, MN (US); Jay Christopher Okeson, Inver Grove Heights, MN (US)

(72) Inventors: Daniel William Dawn, Inver Grove Heights, MN (US); Jay Christopher Okeson, Inver Grove Heights, MN (US)

(21) Appl. No.: 13/847,352

(22) Filed: Mar. 19, 2013

(51) Int. Cl. A01K 1/01

(52) U.S. Cl. CPC A01K 1/011
USPC 119/166

(57) ABSTRACT

A hopper separates waste from cat litter. The hopper may include sidewalls with a top and a bottom. The sidewalls may taper from the top to the bottom. At the bottom of the hopper is a grate. The hopper may be placed on a pail and the cat litter and waste may be poured directly into the hopper. The clean cat litter may pass through the grate and the waste may be caught on the grate and separated from the clean cat littler.

### BACKGROUND OF THE INVENTION

The present invention relates to a device that separates waste from cat litter and, more particularly, to a hopper that includes a grate.

A litter box, sometimes called a sandbox, litter tray, litter pan, or cat box, is an indoor feces and urine disposal box for cats (as well as rabbits, ferrets, small dogs such as Beagles and Chihuahuas, and other pets that naturally or through training will make use of such a repository) that are permitted free roam of a home but who cannot or do not always go outside to relieve themselves.

In the wild, cats naturally excrete in soft or sandy soil for easy burial. They use their paws to cover up in a back sweeping motion to cover their feces. To stimulate this instinctive desire, a litter box's bottom is filled typically with an inch (2.5 cm) or more of cat litter. Litter box filler is a loose, granular material that absorbs moisture and odors such as ammonia. Some litter brands contain baking soda to absorb such odors. The litter material also satisfies a cat's instinctive desire to use an easily-dug material. The most common material is clay, although recycled paper “pellets” and silica-based “crystal” variants are also used.

The environmental impact of using commercial cat litter is a matter of increasing concern. Therefore cat owners are now trying to reuse cat litter. However, removing the liquid and solid waste from the cat litter can be unpleasant. The scoops that are used may be small and waste may be easily dropped on the ground, a user's hands, and clothes. Further, cat owners tend to forget to clean their litter box and end up throwing away all of the litter, which is wasteful.

As can be seen, there is a need for a device for separating waste from clean litter.

### SUMMARY OF THE INVENTION

In one aspect of the present invention, a litter sifting device comprises: a hopper comprising at least one side wall having a top and a bottom; a top rim at the top of the at least one side wall, forming a top opening; a bottom rim at the bottom of the at least one side wall, forming a bottom opening; and a sifting grate enclosed by the bottom rim, wherein the top rim of the side wall has a larger parameter than the bottom rim of the side wall.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is an exploded view of the present invention;

FIG. 3 is a top view of the present invention;

FIG. 4 is a sectional view of the present invention, taken along line 4-4 in FIG. 1, shown in use; and

FIG. 5 is a detailed sectional view of the present invention illustrating the removal of the hopper for litter disposal.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention provides a device that separates waste from clean cat litter. The device may include a hopper with sidewalls having a top and a bottom. The sidewalls may taper from the top to the bottom of the hopper. At the bottom of the hopper is a grate. The hopper may be placed on a pail and the cat litter and waste may be poured directly into the hopper. The clean cat litter may pass through the grate and the waste may be caught on the grate and thereby separated from the clean cat littler.

The present invention may include a sifter that removes cat waste from a cat litter box in order to reuse the clean litter. The present invention may include four solid sides and a sifting grate near the bottom. The present invention may fit snugly in a clumping litter pail or any standard pail. The entire cat waste and litter may be dumped into the sifter. The clean litter may thereby be deposited into the pail and the waste may be disposed of from the sifter. The clean litter in the pail may be reused immediately. Therefore, a user does not have to scoop waste directly from the litter box, cleaning the box every day, and spilling the waste on the floor, clothes or hands. Additionally, the sifter does not get clogged with waste, as the clean litter surrounds the waste in the process and therefore prevents the waste from sticking to the sifter.

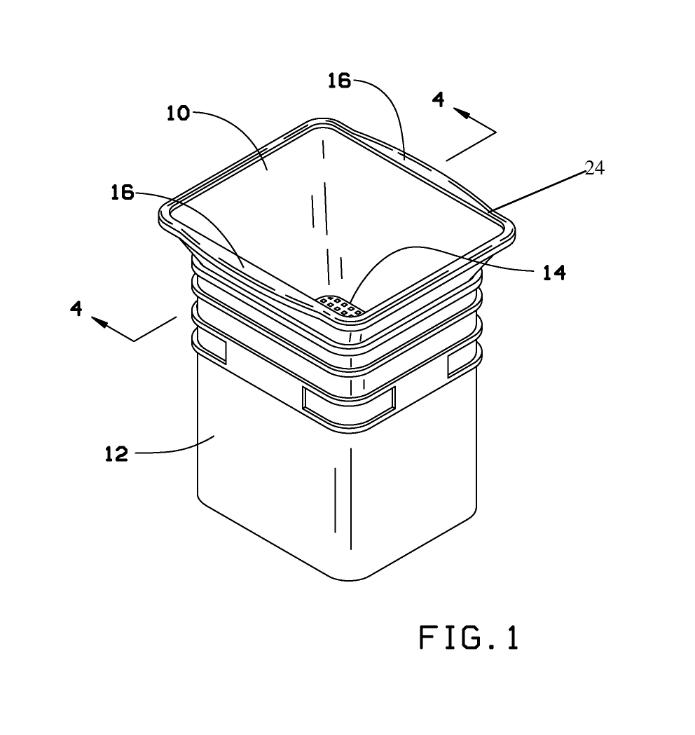

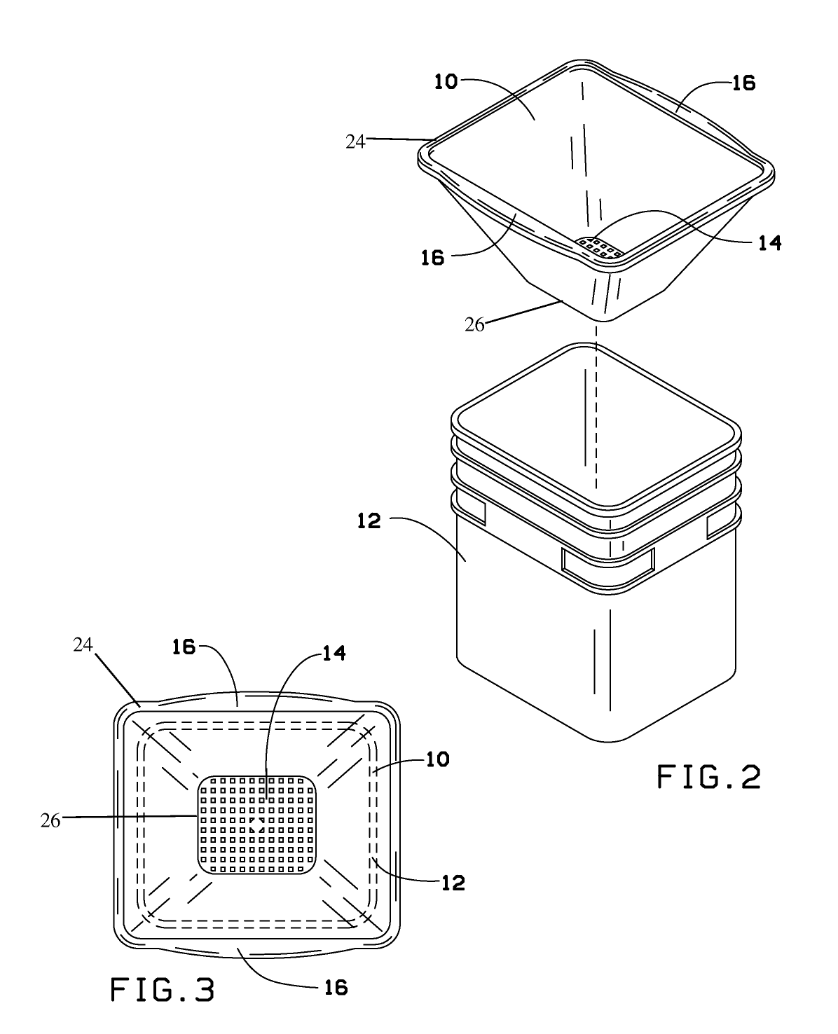

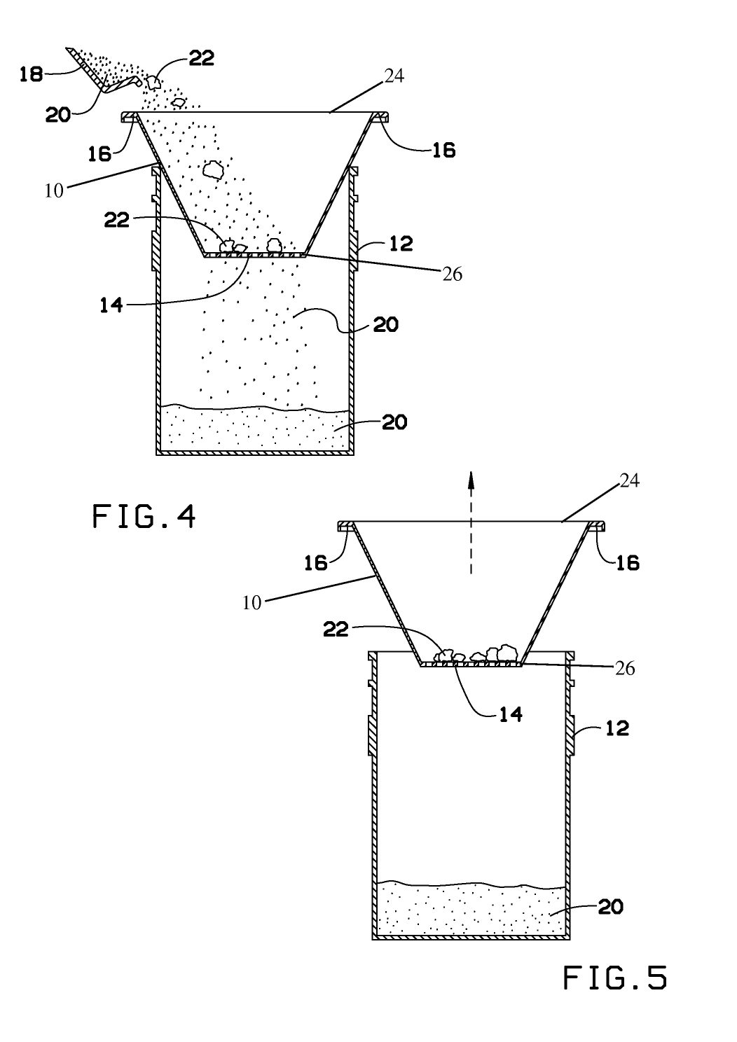

Referring to FIGS. 1 through 5, the sifter may be a hopper with at least one sidewall 10. The sidewalls 10 may include a top and a bottom. The sidewalls 10 may include a top rim 24 at the top and a bottom rim 26 at the bottom. The top rim 24 may form a top opening and the bottom rim 26 may form a bottom opening. The top rim 24 may include a larger parameter than the bottom rim 26. Thereby, the sidewalls 10 may taper from the top rim 24 to the bottom rim 26.

The shape of the hopper may be any shape desired that may perform the functions of the hopper. For example, the shape of the top rim 24 and bottom rim 26 may be square shaped, rectangular shaped, triangular shaped, circular shaped, oval shaped, and the like. When the hopper has a circular shape, there may be only one sidewall 10. However, when the hopper is square or rectangular shaped, the hopper may include four sidewalls 10.

In certain embodiments, the present invention may include a sifting grate 14. The grate 14 may be attached to the inside of the hopper. In certain embodiments, the grate 14 may be located at the bottom of the sidewalls 10 and may be enclosed by the bottom rim 26. The grate 14 may allow clean litter 20 to pass through the bottom opening while collecting waste 22. In certain embodiments, the top rim 24 may include handles 16 for a user to easily grasp the sifter 10 and prop the sifter 10 onto a pail 12.

In certain embodiments, the hopper may include a sidewall 10 with a length of about two and a half feet. The top rim 24 of the side wall may have a diameter of about two and a half feet. The bottom rim 26 may include a diameter that is less than the top rim 24. However, the present invention is not limited to the dimensions above and may be any desired dimensions that may carry out the same or similar purpose.

A pail 12 may be used to collect the clean litter 20 that passes through the grate 14. The clean litter 20 may then be reused. In certain embodiments, the dimensions of the bottom opening are smaller than the dimensions of the pail 12 being used. The dimensions of the top opening may be larger than the dimension of the pail 12 being used. Thereby, a user may place the sifter into the pail 12 and the tapered sidewalls 10 may rest on the edges of the pail's 12 sidewalls. The pail 12 may be a standard five gallon pail, or any squared box clumping litter pail. The grate 14 may mechanically separate, via gravity, the waste 22 from the clean litter 20. The clean litter 20 ends up in the pail and the waste 22 remains in the sifter hopper. The waste 22 may be easily dumped out of the hopper. The clean litter 20 in the pail 12 may be placed back in the litter box 18 for re-use.

A method of using the present invention may include the following. A user may place the bottom of the at least one side wall of the hopper in a pail; and pour used cat litter from a litter box into the top opening of the hopper. The clean cat litter may be funneled through the grate, through the bottom opening, and into the pail. The grate may catch the waste. A user may then dump the waste from the hopper into a waste bin and dump the clean cat litter back into the litter box. By dumping the whole litter box in the hopper, it allows for the clean litter to totally drain out of the box. Litter may not spill and the process may save time as compared to scooping the waste from the litter box. Additionally the sifter doesn't get clogged with waste, as the clean litter surrounds the waste in the process, and makes it unable to stick to the sifter.

It should be understood, of course, that the foregoing relates to exemplary embodiments of the invention and that modifications may be made without departing from the spirit and scope of the invention as set forth in the following claims.

What is claimed is:

1. A litter sifting device comprising:
a hopper comprising at least one side wall having a top and a bottom;
a top rim at the top of the at least one side wall, forming a top opening;
a bottom rim at the bottom of the at least one side wall, forming a bottom opening; and
a sifting grate attached within the hopper,
wherein the top rim of the side wall has a larger parameter than the bottom rim of the side wall.

2. The litter sifting device of claim 1, wherein the at least one side wall tapers from the top to the bottom.

3. The litter sifting device of claim 1, wherein the top rim and the bottom rim have a shape selected from the group consisting of circular, square, rectangular, and triangular.

4. The litter sifting device of claim 3, wherein the top rim and the bottom rim have a square shape.

5. The litter sifting device of claim 4, wherein the at least one side wall is four side walls.

6. The litter sifting device of claim 1, wherein the sifting grate is attached at the bottom rim.

7. The litter sifting device of claim 1, wherein the top rim further comprises at least one handle.

8. The litter sifting device of claim 1, wherein the at least one sidewall has a length of about two and a half feet and the top rim has a diameter of about two and a half feet.

9. A method of using the device of claim 1 comprising:
placing the bottom of the at least one side wall of the hopper in a pail;
pouring used cat litter from a litter box into the top opening of the hopper;
funneling the clean cat litter through the bottom opening and into the pail; and
catching waste on the grate.

10. The method of claim 9, further comprising dumping the waste from the hopper into a waste bin and dumping the clean cat litter back into the litter box.
